(19) United States
(12) Patent Application Publication
(10) Pub. No.: US 2005/0146631 A1
(43) Pub. Date: Jul. 7, 2005

(54) In-camera cropping to standard photo sizes

(76) Inventors: Michael J. Shelton, Boise, ID (US); Travis J. Parry, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/754,082

(22) Filed: Jan. 7, 2004

(51) Int. Cl. H04N 5/222

(52) U.S. Cl. 348/333.12

(57) ABSTRACT

A digital camera allows the photographer to specify an aspect ratio at which a photograph will be used, typically an aspect ratio of a standard photographic print format. The aspect ratio may optionally be specified by indicating which standard format is to be used. The aspect ratio may optionally be specified by a numerical value. The camera may optionally alter its preview image to match the desired aspect ratio. The resulting photograph may optionally be cropped to the desired aspect ratio before being stored. The resulting photograph may optionally be stored in its uncropped size, and aspect ratio and cropping information stored with it as metadata.

### FIELD OF THE INVENTION

The present invention relates generally to photography.

### BACKGROUND OF THE INVENTION

A common difficulty in photography arises from the fact that the aspect ratio, the ratio of width to height, of the image area of a camera typically does not match the aspect ratios of several common photographic print formats. For example, the image area of a 35 millimeter film camera is 36 millimeters wide and 24 millimeters high, giving an aspect ration of 36:24, or 1.5:1. Some digital cameras also have an image area aspect ratio of 1.5:1. An 8×10 inch print, however, has an aspect ratio of 10:8, or only 1.25:1. When a photograph taken with a camera whose aspect ratio is 1.5:1 is printed on 8×10 inch paper stock, one sixth of the image is typically omitted because the camera's image area enlarged to 8 inches tall would be 12 inches wide.

Most casual photographers have their photographic printing done by commercial printing labs that are highly automated, and give the photographer little control over how the photographs are printed. In the above example, the photographer may have no way to specify which one sixth of the available image will be omitted so that the remainder can fit on 8×10 inch print stock, and may be disappointed with the choice made by the automated printing lab.

Existing ways to avoid this problem are unsatisfactory. In some cases, the photographer could choose a standard print format with the same aspect ratio as the camera. For example, 4×6 inch prints would match photographs taken with a camera whose aspect ratio is 1.5:1. However, this would typically limit the photographer to one print size, and may not even be possible. For example, many digital cameras use an aspect ratio of 4:3, which does not match any standard print format.

The photographer could compose all of his photographs to include a larger field of view that is actually needed, and then use digital imaging equipment to crop the photographs to the desired aspect ratio later. However, this requires the photographer to remember to alter his composition, requires extensive and often tedious manual intervention, and may compromise the resolution of the photographs.

A few digital cameras allow the photographer to choose between a 3:2 aspect ratio and a 4:3 aspect ratio, but these choices still do not match may common uses of photographs.

Some photographic printing labs and some home digital photography software allow the full image area to be printed on paper of any standard size, scaling the photograph to fit on the paper in the most restrictive dimension, and simply leaving an unprinted band on the edges of the paper in the other dimension. However, the resulting prints, typically having white stripes on one or two edges, are unusual and may be objectionable.

What is needed is a convenient way to give the photographer more control over the printed composition of a photograph in a standard print format.

### SUMMARY OF THE INVENTION

A digital camera allows the photographer to specify an aspect ratio at which a photograph will be used, typically an aspect ratio of a standard photographic print format. The aspect ratio may optionally be specified by indicating which standard format is to be used. The aspect ratio may optionally be specified by a numerical value. The camera may optionally alter its preview image to match the desired aspect ratio. The resulting photograph may optionally be cropped to the desired aspect ratio before being stored. The resulting photograph may optionally be stored in its uncropped size, and aspect ratio and cropping information stored with it as metadata.

### BRIEF DESCRIPTION OF THE DRAWINGS

FIG. 1 depicts a simplified block diagram of a digital camera.

FIG. 2 shows a digital camera in a typical example mode of use.

FIG. 3 shows a digital camera being configured, through its user controls, in accordance with an example embodiment of the invention

FIG. 4A depicts the camera in a preview mode in accordance with an example embodiment of the invention.

FIG. 4B depicts the camera in a second preview mode in accordance with an example embodiment of the invention.

FIG. 4C depicts the camera in a third preview mode in accordance with an example embodiment of the invention.

FIG. 5 depicts a digital camera in accordance with another example embodiment of the invention.

FIG. 6 shows a camera that has been placed in a mode for selecting an arbitrary aspect ratio.

FIG. 7 illustrates a camera connected to an external device for configuration.

### DETAILED DESCRIPTION OF THE PREFERRED EMBODIMENT

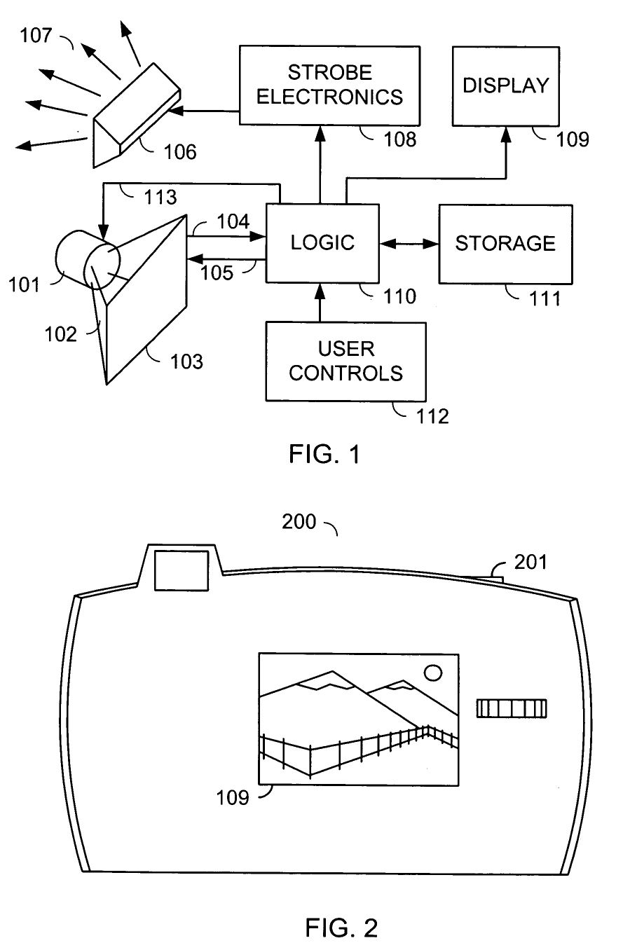

FIG. 1 depicts a simplified block diagram of a digital camera. A lens 101 gathers light from a scene (not shown). The lens redirects the light so that the redirected light 102 forms an image of the scene on an electronic array light sensor 103. Electronic array light sensor 103 may be a charge-coupled device (CCD) sensor, an active pixel complementary metal oxide semiconductor (CMOS) sensor, or another kind of sensor. Image data 104 from electronic array light sensor 103 is transmitted to a logic unit 110. The logic unit may comprise a microprocessor, a digital signal processor, one or more application specific integrate circuits (ASICs), or some combination of these, and controls the operation of electronic array light sensor 103 using control signals 105. Logic unit 110 may also control the operation of lens 101 using control signals 113. Logic unit 110 may also process digital photographs in various ways, including applying image compression techniques to them. The camera may comprise a strobe 106 for supplying light 107 to the scene. Strobe 106 may be controlled by strobe electronics 108, which are in turn controlled by logic unit 110.

The camera also comprises storage 111, which may include nonvolatile memory for relatively long term storage of digital photographs taken by the camera. Some or all of the storage may be incorporated as part of logic unit 110. For example, the logic unit may comprise some flash memory, which is a form of nonvolatile re-writable semiconductor memory. Storage 111 may also comprise other kinds of memory such as random access memory (RAM), read-only memory (ROM), electrically erasable programmable read-only memory (EEPROM), or other kinds of memory. Logic unit 110 may use memory, including some of storage 111, to hold intermediate computational results, executable microprocessor instructions, configuration information, or the like. At least a portion of storage 111 is used for relatively long term storage of digital photographs.

A digital photograph is a set of numerical values corresponding to locations in the scene being photographed. Typically the numerical values record the brightness of the corresponding scene locations, and may also record color information. A file holding a digital photograph typically includes header information describing the size of the image, the data format of the numerical values, and other descriptive information. The image data in the digital photograph may be compressed, either with some loss of image information or losslessly, so that storage memory is conserved. The term digital photograph may also refer to the file holding a digital photograph. A digital photograph may also sometimes be referred to as simply a “photograph”.

The camera also comprises a display 109, which may be used for various purposes. Display 109 is typically a liquid crystal display, but may be a viewfinder microdisplay, or another kind of display. Display 109 may be used in a preview mode, whereby the camera repetitively displays its rendition of the scene to aid the photographer in composing a photograph. Display 109 may also be used to review photographs for quality and composition. Display 109 may also be used in conjunction with user controls 112 to aid the photographer in controlling the function of the camera. For example, a selection of choices may be shown on display 109, and the user may select from the choices using user controls 112. User controls 112 may comprise buttons, dials, switches, touchpads, or other input devices.

FIG. 2 shows a digital camera 200 in a typical example mode of use. During composition of a photograph, camera 200 repetitively displays, on display 109, a preview image of the scene to be photographed. Each preview image is a transitory digital photograph of the scene encompassed by the camera's field of view. These preview images assist the photographer in composing a “final” photograph, and may also be used by the camera logic 110 to evaluate the exposure level required for a pleasing photograph, to assist in focusing the lens 101, or for other purposes. The preview images are typically not stored by the camera beyond the time needed for their display and for any analysis done by camera logic 110. When the photographer is satisfied with the composition, he can cause the camera to take a final photograph by fully actuating shutter release button 201. The camera may perform other automatic functions during the time between the full actuation of the shutter release button 201 and the taking of the final photograph. A final photograph, in contrast to the preview images repeatedly taken earlier, is stored in the camera's storage 111 where it is available for later retrieval. The final photograph typically stays in storage 111 until it is affirmatively deleted by the user.

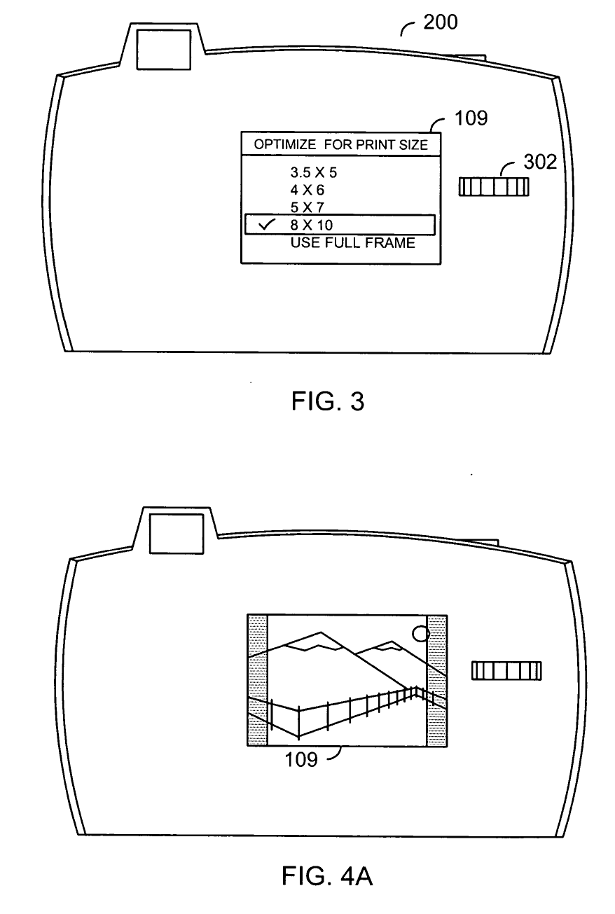

FIG. 3 shows digital camera 200 being configured, through its user controls, in accordance with an example embodiment of the invention. In FIG. 3, camera logic 110 has displayed on display 109 a menu of choices. The photographer can select from the menu of choices using a user control such as example control 302. Example control 302 is an edge drive jog encoder, available from the Matsushita Electric Corporation of America in Secaucus, N.J., and allows the photographer to interact with logic 110 in navigating the user interface of camera 200. One of skill in the art will recognize that other kinds of controls and user interface presentations may be used within the scope of the attached claims.

In FIG. 3, by way of example, the photographer has indicated that he wishes to take photographs with an aspect ratio compatible with the 8×10 inch print format, which has an aspect ratio of 1.25:1. Once this preference is communicated to the camera, the camera stores it for use during the taking of future photographs.

Table 1 lists some standard photographic prints and their nominal aspect ratios. The actual dimensions of a photographic print may vary somewhat due to manufacturing tolerances.

TABLE 1
Standard Photographic Print Formats

| Standard Format | Aspect Ratio |
|---|---|
| (Dimensions in inches) | (Width/height) |
| 3.5 × 5 | 1.43 |
| 4 × 6 | 1.50 |
| 5 × 7 | 1.40 |
| 8 × 10 | 1.25 |
| 11 × 14 | 1.27 |

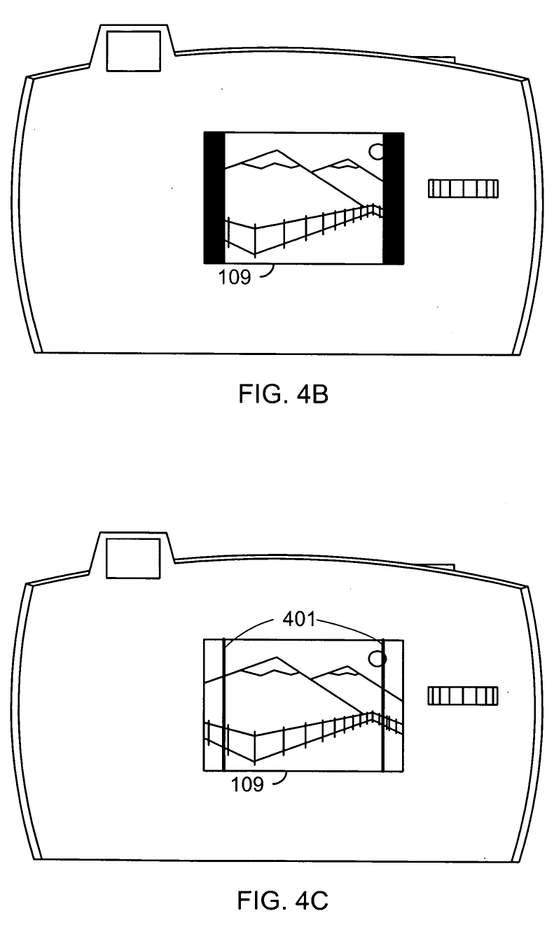

FIG. 4A depicts the camera in a preview mode in accordance with an example embodiment of the invention. In FIG. 4A, the camera, under the control of logic 110, has displayed the preview image on display 109 with a portion indicated to be outside the specified aspect ratio. The term “outside the specified aspect ratio”, for the purposes of this disclosure, refers to portions of a photograph that would be removed in the process of cropping the photograph to the specified aspect ratio, while leaving one dimension, either length or height, of the photograph unchanged. In FIG. 4A, the camera has “grayed out” enough of the preview image that the remaining portion has an aspect ratio of 1.25:1. Graying out of a portion of a display is a common user interface technique in which a part of the display is presented with reduced image contrast. Because the example camera sensor and display 109 have an aspect ratio of 1.5:1, the portion of the preview image that is grayed out is at the ends of display 109. The display in FIG. 4A reveals that when the impending photograph is printed as an 8×10 inch print, its composition may not be as pleasing as might have appeared had the whole display 109 been considered in composing the photograph. This advance indication gives the photographer an opportunity to re-compose the photograph to a composition suited to the intended print format.

The graying out of the image area that is outside the requested aspect ratio is but one way the indication might be accomplished. The area outside the requested aspect ratio may be blacked out in the preview display, as shown in FIG. 4B, or a set of lines 401 could be drawn on the preview image indicating the limits of the requested aspect ratio, as shown in FIG. 4C, or some other technique could be used. The aspect ratio indication in FIG. 4A shows the desired image area centered in the preview image shown on display 109. Alternatively, all of the excluded area could be taken from one side of the preview image, or some intermediate location may be chosen.

Once the photographer has taken a final photograph, the camera may proceed in one of several ways.

In one example embodiment, the camera crops the final photograph to the aspect ratio specified, and stores the cropped photograph. Cropping is the process of removing portions of the photograph, typically along one or more edges, to reduce the size of the photograph. Cropping can change the aspect ratio of a photograph when only the length or only the width of the photograph is cropped, or when the length and width of the photograph are cropped in different proportions. In a digital camera in accordance with an example embodiment of the invention, logic unit 110 performs cropping by rearranging the digital values of the digital photograph in storage area 111.

For example, a typical 6 megapixel electronic array sensor produces images in its native resolution that are 3000 pixels wide and 2000 pixels high, resulting in an aspect ratio of 1.5:1. A camera in accordance with an example embodiment of the invention that has been instructed that the user wishes an aspect ratio compatible with the 8×10 inch print format may discard some pixels on the left or right edge, or both left and right edges, of a digital photograph to produce a resulting digital photograph that is 2500 pixels wide and 2000 pixels high, thus having an aspect ratio of 1.25:1. This resulting cropped digital photograph may then be stored, excluding the discarded pixels.

Many digital cameras provide camera options for producing photographs that encompass the camera's entire field of view, but are rendered at a lower resolution than the native format of the camera's sensor. For example, a camera using the 6 megapixel sensor described above may allow users to produce photographs in various reduced resolutions, such as 1500 by 1000 pixels, in order to conserve storage space. The selective cropping to achieve an aspect ratio compatible with a standard print format may be applied to these reduced resolution photographs as well.

In another example embodiment, the camera stores a digital photograph that includes the entire area of the camera's sensor (whether in full resolution or a reduced resolution as described above), but also stores the photographer's indication of the desired aspect ratio as metadata in the digital photograph file. For example, using a camera with the 6 megapixel sensor described above and assuming full resolution, if the photographer has indicated that he wishes an aspect ratio compatible with an 8×10 inch print format, the camera stores the entire 3000×2000 pixel photograph, but also records the photographer's indication that a portion of the photograph 2500×2000 pixels may be selected for producing an 8×10 inch print. By way of example, this indication may be stored in a comment or “APP” segment of a JPEG file, or may be stored as tag data in a TIFF file. Pending U.S. patent application Ser. No. 10/686,081, entitled “System and method to allow undoing of certain digital image modifications” and having a common assignee with the present application, describes how to store metadata in these file formats, and is hereby incorporated for all that it discloses. Storing the entire available image preserves image information that would otherwise be discarded, and may allow the photographer to select other print formats at a later time.

In yet another example embodiment, the camera stores a digital photograph that includes the entire area of the camera's sensor (whether in full resolution or a reduced resolution as described previously), and then provides an in-camera cropping function that allows the photographer to crop the photograph, using the camera's user controls, so that the resulting cropped photograph is compatible with a standard print format.

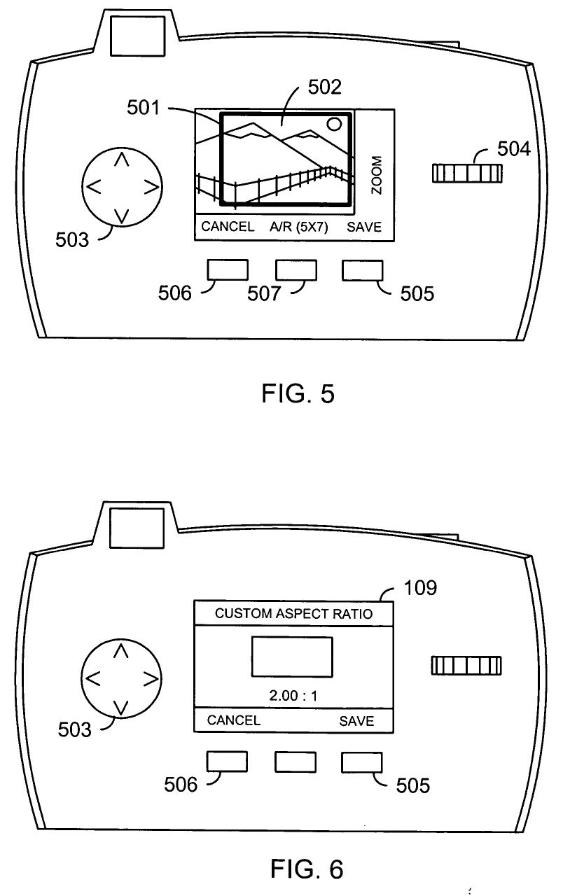

FIG. 5 depicts a digital camera in accordance with this example embodiment of the invention. In FIG. 5, the camera has been placed in an in-camera cropping mode. The display indicates that the camera has been previously instructed that photographs will be cropped to an aspect ratio compatible with the 5×7 inch print format. A selection rectangle 501 is imposed on a representation of the scene 502 previously photographed. Several camera controls work in concert to accomplish the cropping. A four-way rocker switch 503 allows the user to move the selection rectangle around the scene representation by depressing the rocker switch at any of its four directional arrow markings. Edge drive jog encoder 504 allows the user to enlarge or reduce the size of the selection rectangle, creating an effect similar to the action of a digital zoom feature. Button 505 allows the user to effect the cropping and save the resulting cropped digital photograph. Button 506 allows cancellation of the crop operation, leaving the stored photograph unchanged. Button 507 may scroll through different aspect ratio choices, causing the camera to change the aspect ratio of selection rectangle 501 in response.

This example combination of controls allows the camera user to crop a previously taken photograph to an aspect ratio compatible with any supported print format, and to select what portion of the photograph is used to fill the selection rectangle. The camera user can conveniently choose the aspect ratio that is compatible by selecting the print format by its common designation.

As in the earlier example embodiments, the camera may store only the cropped image, or may store the entire original image with the cropping information stored as metadata. The cropping function can work equally well with full resolution photographs, as well as those taken with space-saving reduced resolution. Multiple versions of the photograph could be stored with different aspect ratios, or a full resolution image could be stored with more than one set of metadata cropping information

In still another example embodiment, the camera user can select a custom or arbitrary aspect ratio. FIG. 6 shows an example user interface arrangement for this function. In FIG. 6, the camera has been placed in a mode for selecting an arbitrary aspect ratio. Display 109 shows a rectangle having the aspect ratio currently selected (2.00:1 in the example display). The camera user can use rocker switch 503 to increment or decrement the currently specified aspect ratio. For example, pressing the upward-pointing arrow portion of rocker switch 503 may cause the selected aspect ratio to increase by 0.01 units, and the camera my redraw the rectangle to illustrate the appearance of the selected ratio. Buttons 505 and 506 allow the user to save the current selection, or cancel the changes that may have been indicated.

In this way, the camera user can select an aspect ratio by its numerical value. Of course, the user could select a numerical value that corresponds to a standard photographic print format. For example, the user could select an aspect ratio of 1.43:1, which corresponds very closely to the standard print format of 3.5×5 inches. A camera user could select an aspect ratio of 1:1, indicating a square photographic format, or even an aspect ratio in which the width is less than the height.

In a variation of this example embodiment, the user can select an arbitrary aspect ratio by selecting an arbitrary width and an arbitrary height for the desired photograph. The camera can then compute the resulting aspect ratio, or simply use the specified width and height to compute the appropriate cropping boundaries. The width and height may be specified in inches, centimeters, or another appropriate unit of measure.

Once the custom aspect ratio has been communicated to the camera, it may be used by the camera as previously described. The camera may alter its preview mode display to allow the photographer to compose photographs using a display of only the portions of the scene within the selected aspect ratio. The resulting final photograph may be cropped to the selected aspect ratio before being stored, or the cropping information may be stored as metadata with a stored photograph that includes the entire area of the camera's sensor. The selected aspect ratio may be applied to a full-resolution photograph, or a reduced-resolution photograph.

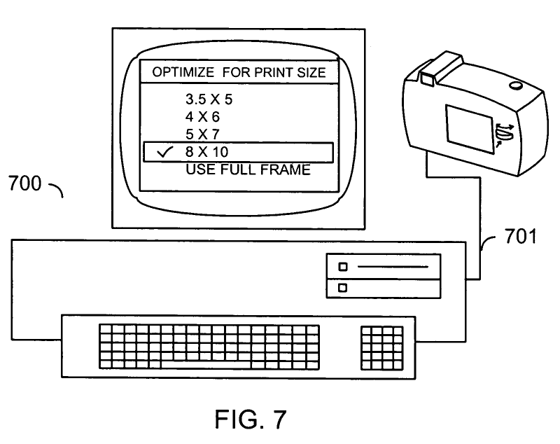

As an alternative to using camera user controls to select an aspect ratio, at least a portion of the camera user interface may be presented on a computer or other device external to the camera. FIG. 7 illustrates this arrangement. In this arrangement, the user uses the external device 700 to choose an aspect ratio at which the camera should produce photographs, and then the selected aspect ratio is communicated to the camera by way of a communication link 701. The communication link may be a USB interface, an optical link, a wireless link, or another kind of communication link. This arrangement has the advantage of letting the camera user configure a large number of camera settings, including an aspect ratio, using the larger and more convenient display of the external computer or other device.

The foregoing description of the present invention has been presented for purposes of illustration and description. It is not intended to be exhaustive or to limit the invention to the precise form disclosed, and other modifications and variations may be possible in light of the above teachings. The embodiments were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

1. A digital camera, comprising a user interface that allows the specification of an aspect ratio at which to produce a digital photograph taken by the camera, and wherein the specification of an aspect ratio is accomplished by indicating a standard photographic print format.

2. The digital camera of claim 2, wherein indicating a standard photographic print format comprises selecting a standard photographic print format from a list of standard photographic print formats.

3. The digital camera of claim 1, further comprising a preview mode, and wherein the camera indicates, during the preview mode, that a portion of a scene viewed by the camera is outside the specified aspect ratio.

4. The digital camera of claim 3, wherein the camera indicates that a portion of a scene viewed by the camera is outside the specified aspect ratio by displaying that portion as grayed out in a display of a preview image.

5. The digital camera of claim 3, wherein the camera indicates that a portion of a scene viewed by the camera is outside the specified aspect ratio by displaying that portion as blacked out in a display of a preview image.

6. The digital camera of claim 3, wherein the camera indicates that a portion of a scene viewed by the camera is outside the specified aspect ratio by displaying, in a display of a preview image, lines indicating the limits of the specified aspect ratio.

7. The digital camera of claim 1, further comprising a preview mode in which the camera does not display any portion, of a scene that is viewed by the camera, that is outside the specified aspect ratio.

8. The digital camera of claim 1, wherein the camera crops the digital photograph to the specified aspect ratio, and stores the resulting cropped digital photograph.

9. The digital camera of claim 1, wherein the camera stores the digital photograph at its uncropped size, and stores at least one aspect ratio specification as metadata with the digital photograph.

10. The digital camera of claim 9 wherein the digital photograph is stored in a JPEG file, and the aspect ratio specification is stored in an APP segment in the JPEG file.

11. The digital camera of claim 9 wherein the digital photograph is stored in a JPEG file, and the aspect ratio specification is stored in a comment segment in the JPEG file.

12. The digital camera of claim 9 wherein the digital photograph is stored in a TIFF file, and the aspect ratio specification is stored in tag data in the TIFF file.

13. The digital camera of claim 1 wherein the aspect ratio specification occurs before the digital photograph is taken.

14. The digital camera of claim 1 wherein the aspect ratio specification occurs after the digital photograph is taken.

15. A digital camera, configured to allow the specification of an arbitrary aspect ratio at which to produce a photograph taken by the camera.

16. The digital camera of claim 15 wherein the arbitrary aspect ratio is specified by a numerical value.

17. The digital camera of claim 15 wherein the arbitrary aspect ratio is specified by specifying a width and a height for the photograph.

18. A digital camera user interface configured to allow a user of the digital camera to specify an aspect ratio at which to produce a photograph taken by the digital camera, and wherein the aspect ratio is specified by designating a standard photographic print format.

19. The digital camera user interface of claim 18, wherein the user interface presents a list of standard photographic print formats, and the camera user, using user controls, selects a standard photographic print format from the list.

20. The digital camera user interface of claim 18, further comprising a display, and wherein the display is used to display a preview image, the preview image containing an indication that a portion of a scene is outside the specified aspect ratio.

21. The digital camera user interface of claim 20, wherein the indication that a portion of a scene is outside the specified aspect ratio is performed by showing that portion as grayed out in the display.

22. The digital camera user interface of claim 20 wherein the indication that a portion of a scene is outside the specified aspect ratio is performed by showing that portion as blacked out in the display.

23. The digital camera user interface of claim 20 wherein the indication that a portion of a scene is outside the specified aspect ratio is performed by showing lines demarking the limits of a scene portion that is within the specified aspect ratio.

24. The digital camera user interface of claim 18 further comprising a display, and wherein the display is used to display a preview image, the preview image not containing any portion, of a scene viewed by the camera, that is outside the specified aspect ratio.

25. The digital camera user interface of claim 18 wherein the aspect ratio is specified using user controls on the camera.

26. The digital camera user interface of claim 18 wherein the aspect ratio is specified using an external device, and the specified aspect ratio is communicated from the external device to the camera.

27. A digital camera user interface configured to allow a user of the digital camera to specify an arbitrary aspect ratio at which to produce a photograph taken by the digital camera.

28. The digital camera user interface of claim 27, wherein the arbitrary aspect ratio is specified by a numerical value.

29. The digital camera user interface of claim 27, wherein the arbitrary aspect ratio is specified by specifying a height and a width for the photograph.

30. A method, comprising specifying, to a digital camera, an aspect ratio at which a photograph taken by the digital camera is to be used, by choosing a standard photographic print format from a list of standard photographic print formats, the specified aspect ratio taking the value of the aspect ratio of the chosen standard photographic print format.

31. A method, comprising specifying, to a digital camera, an arbitrary aspect ratio at which a photograph taken by the digital camera is to be used.

32. The method of claim 31, wherein specifying an arbitrary aspect ratio comprises selecting a numerical value for the aspect ratio.

33. The method of claim 31, wherein specifying an arbitrary aspect ratio comprises selecting a width and a length for the photograph.

34. A method, comprising:
a) accepting a designation of a standard photographic print format; and
b) using an aspect ratio of the standard photographic print format as a specified aspect ratio at which a digital photograph is to be produced by a digital camera.

35. The method of claim 34, wherein the designation of a standard photographic print format is accomplished by selecting a standard photographic print format from a list of standard photographic print formats.

36. The method of claim 34, further comprising:
a) displaying, on a display on the digital camera, a preview image; and
b) indicating, in the preview image, a portion of the preview image that is outside the specified aspect ratio.

37. The method of claim 36 wherein indicating a portion of the preview image is accomplished by showing that portion as grayed out in the display.

38. The method of claim 36 wherein indicating a portion of the preview image is accomplished by showing that portion as blacked out in the display.

39. The method of claim 36 wherein indicating a portion of the preview image is accomplished by showing lines in the display delimiting that portion of the preview image that is outside the specified aspect ratio.

40. The method of claim 34, further comprising:
a) displaying, on a display on the digital camera, a digital photograph taken by the digital camera; and
b) overlaying, on the digital photograph displayed on the display, a selection rectangle having an aspect ratio equal to the specified aspect ratio.

41. The method of claim 40, further comprising accepting directions for moving the selection rectangle.

42. The method of claim 40, further comprising accepting directions for resizing the selection rectangle.

43. The method of claim 34, further comprising:
a) storing the digital photograph at its uncropped size; and
b) storing at least one specified aspect ratio as metadata with the digital photograph.

44. The method of claim 43, wherein the digital photograph is stored in a JPEG file, and the specified aspect ratio is stored in an APP segment in the JPEG file.

45. The method of claim 43, wherein the digital photograph is stored in a JPEG file, and the specified aspect ratio is stored in a comment segment in the JPEG file.

46. The method of claim 43, wherein the digital photograph is stored in a TIFF file, and the specified aspect ratio is stored in tag data in the TIFF file.

47. A method, comprising accepting into a digital camera a specification of an arbitrary aspect ratio at which to produce photographs taken by the digital camera.

48. The method of claim 43 wherein the specification of an arbitrary aspect ratio is accomplished by specifying a numerical value for the aspect ratio.

49. The method of claim 43 wherein the specification of an arbitrary aspect ratio is accomplished by specifying a length and a width for a photograph.
